(19) United States
(12) Patent Application Publication
(10) Pub. No.: US 2005/0237567 A1
(43) Pub. Date: Oct. 27, 2005

(54) Method and apparatus for creating and editing a library of digital media documents

(75) Inventor: Patrick William Morris, West Molesey (GB)

Correspondence Address: FITZPATRICK CELLA HARPER & SCINTO, 30 ROCKEFELLER PLAZA, NEW YORK, NY, 10112, US

(73) Assignee: CANON EUROPA NV

(21) Appl. No.: 11/082,943

(22) Filed: Mar. 18, 2005

(30) Foreign Application Priority Data
Mar. 19, 2004 (GB) 0406206.3

(51) Int. Cl. G06F 15/00

(52) U.S. Cl. 358/1.15

(57) ABSTRACT

A system is described in which central images are stored at a central server and local images, corresponding to the central images, are stored at one or more local terminals. A local image can be modified to generate a modified local image and modification data describing the modifications made sent to the central server so that the central server can create a modified central image that corresponds to the modified local image without requiring the image as modified to be transmitted from the local terminal to the central server. Similarly, modifications can be made to a central image and modification data describing the modifications made sent to a local terminal so that the local terminal can create a modified local image corresponding to the modified central image without requiring the modified central image to be sent from the central server to the local terminal.

This invention relates to an image communication device, method and system for modifying images and can be used, for example, with digital galleries or albums of digital still images or moving images.

Recently, digital images and video films have become increasingly popular; the use of digital cameras and digital video cameras has increased. Memory is also becoming available in increasingly large capacities and at lower prices. For instance, a large amount of digital images or video can be stored on Digital Versatile Disks, Compact Disks, memory cards, hard disks, digital tape cartridges, etc. As a consequence, there is a large capacity for storing digital images and digital video films. Nevertheless, problems have been encountered in organising the storage and retrieval of such data.

A solution consists in creating and displaying digital albums on a computer. To assist users in creating and displaying digital albums on computer systems, graphical interfaces have been developed.

Digital images and video films are increasingly popular amongst professional photographers, journalists, etc. For instance, professional photographers use the Internet to promote their work and to sell their products. Consequently, they must be able to design as well as easily and rapidly create digital albums, which highlight their work in the best possible way.

To assist users, such as professional reporters and photographers, in designing digital albums, Internet services offer to store user digital albums as well as user digital images or digital video films on remote large capacity memories. These services also provide online editing solutions to create digital albums.

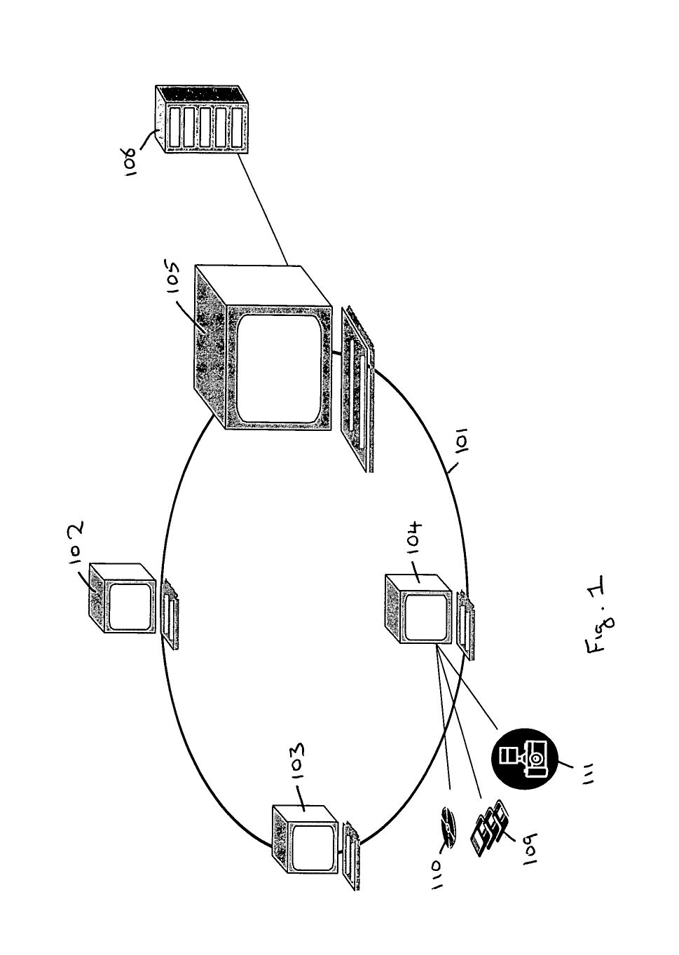

FIG. 1 is an overview of a networked system that allows users to store and edit centrally stored digital images from local terminals. As shown in FIG. 1, a server computer 105 communicates with a user using one of user terminals 102, 103 and 104 via a network 101.

The network 101 may be an Internet network. For example, communication between the server and user terminals can be through a TCP/IP protocol. Alternatively, the user may communicate with the server 105 via an intranet network.

The user terminal 104 is a personal computer, such as a laptop, connected, via a modem or telephone lines or a special network connection (ISDN, etc.) to the server 105. The user terminal 104 contains, in a conventional manner, one or more processors, memories, graphics cards, etc. together with a display means and user input devices (keyboard, mouse, trackball etc.). The user terminal 104 also comprises, or is connected to, data storage means 109, 110, such as hard disks, floppy disks, DVD, CD, disk/tape cartridges, flash memory cards etc. User terminals 102 and 103 are arranged in a similar manner.

Optionally, the user can be connected to the network through other equipment, such as cellular phones, laptop PCs, Set Top Boxes, PDAs, digital TV, etc.

The server 105 comprises, or is connected to, data storage means 106 having a large storage capacity, such as hard disks, tape or disk cartridges.

After being connected to the server 105 in a conventional manner, a user can transfer digital images or video film data, stored on any of the storage means 109, 110 linked to his terminal 104, from his terminal to the server 105. The user can either transfer data representing full digital images or digital video films or compressed data or data representing miniaturised digital images, so called thumbnails.

A digital camera 111, provided with a flash memory card or a flash memory box 112 can be connected to the terminal 104, with digital pictures being transferred from the flash memory card to a storage means of the computer 104. The digital camera 111 can be connected to the terminal 104 in order to transfer digital images stored in the camera to the server 105. Alternatively, a digital camera that is able to connect directly to the network 101 can transfer files directly to the server 105.

The user can, at any time, connect to the server via one of the local terminals 102, 103 or 104 and view the digital images that have previously been uploaded to the server 105. Optionally, other users (either selected or not) can be given access to view the digital images.

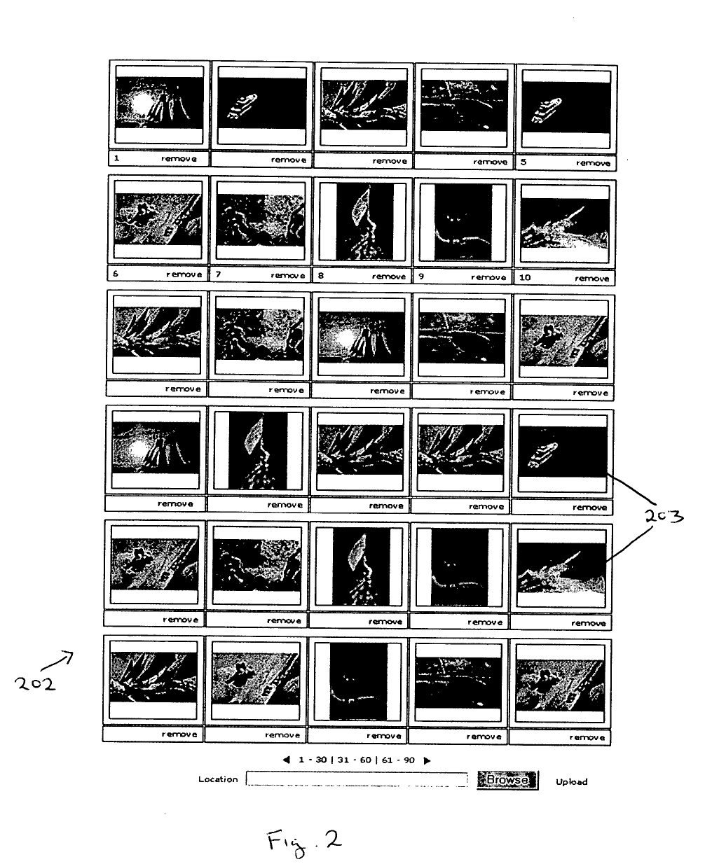

Digital images can be organised into galleries, such as the digital gallery indicated generally by the reference numeral 202 in FIG. 2. The digital gallery 202 includes a number of thumbnails 203.

A problem with existing online digital galleries is that communications between servers and user terminals are often slow or subject to failure, especially when the network is overloaded or when the amount of data transferred is large. Using current online editing solutions is inefficient, complicated and time-consuming. Also connections between servers and user terminals can be expensive, especially if the connection is maintained for long periods of time.

Further, users may wish to arrange and modify images at times when a connection to a server is not possible. For example, a photographer may take many images at a remote location. It would be useful to be able to arrange those images without having to secure an internet connection first.

A further problem exists with modifying images stored in a central location from a local terminal. Images can be downloaded to a local terminal, edited at the local terminal, and then uploaded back to the central server. This results in a large transfer of data to and from the server. Furthermore, the quality of the digital image can be significantly reduced after multiple modifications have been made in this manner.

It is an object of the present invention to address at least some of the above-mentioned problems.

The present invention provides an image communication device connectable to a server storing central images with unique identifiers respectively associated with the central images, the device comprising:
means for storing local images corresponding to the central images;
means for modifying a local image included in the local images to generate a modified local image;
means for generating modification data indicating modification made by said modifying means; and
means for transmitting the modification data to the server together with one of the unique identifiers identifying one of the central images so that the server creates a modified central image by using the transmitted modification data and the central image identified by the transmitted unique identifier without requiring transmission of image data from the device to the server.

Clearly in many situations sending the modification data to the server will result in much less data being transferred than sending a copy of the local image as modified.

It should be noted that corresponding images do not need to be identical, i.e. a particular local image may correspond to a central image without being identical to it. Consider the case where an image is downloaded from the server to a local storage means to provide a local copy of the central image. The local image may have a lower resolution than the central image to reduce the amount of data that needs to be transferred. This lower resolution local image will still correspond to the central image and modifications, such as cropping or rotating the local image, can be made to the central image, even though the original images are not identical. Alternatively, the local image may include details not included in the central image when the local image was uploaded to generate the central image.

A storing means may be provided for storing the modification data capable of indicating a set of modifications carried out by said modifying means while the device is disconnected from the server. The transmitting means may transmit the modification data after the device is subsequently connected to the server. This enables the images to be modified offline and the modifications uploaded later. This would be useful, for example, to a photographer taking images when he does not have access to the central server.

Means may be provided for receiving modification data indicating modification carried out in the server together with one of the unique identifiers, and wherein said modifying means may be capable of modifying the local image corresponding to the central image identified by the received unique identifier to create a modified local image by using the received modification data without requiring transmission of image data from the server to the device.

The received modification data may be capable of indicating a set of modifications carried out in the server and said modifying means may include means for generating one or more optimised modifications corresponding to the set of modifications and means for applying the optimised modifications to the local image. By generating an optimised list of modifications, for example by combining successive rotations, the number of modifications madde to the original image can be kept to a minimum, thereby keeping the image quality high.

The device may be connectable to the server via an Internet connection. Other connections, such as Intranet connections, are also possible.

The present invention also provides an image communication device connectable to a local terminal storing local images, the device comprising:
means for storing central images with unique identifiers respectively associated with the central images;
means for receiving modification data indicating modification carried out in the local terminal together with one of the unique identifiers; and
means for modifying a central image, which is stored in said storing means as one of the central images, identified by the transmitted unique identifier by using the transmitted modification data without requiring transmission of image data from the local terminal.

The modification data received by said receiving means may be capable of indicating a set of modifications carried out in the local terminal and said modifying means may include means for generating one or more optimised modifications corresponding to the set of modifications and means for applying the optimised modifications to the central image.

The said modifying means may be capable of modifying a central image included in the central images irrespective of the modification data transmitted from the local terminal.

The device may further comprise:
means for generating modification data indicating modification made by said modifying means; and
means for transmitting the modification data to the local terminal together with one of the unique identifiers identifying one of the central images so that the local terminal creates a modified local image by using the transmitted modification data and the local image identified by the transmitted unique identifier without requiring transmission of image data from the device to the local terminal.

The present invention further provides an image communication system comprising a server and a local terminal connectable to the server, wherein central images are stored in the server with unique identifiers respectively associated with central images, and wherein local images corresponding to the central images are stored in the local terminal, the system further comprising:
means for modifying, at the local terminal, a local image included in the local images to generate a modified local image;
means for transmitting modification data indicating modification made by said modifying means from the local terminal to the server together with one of the unique identifiers identifying one of the central images; and
means for creating, in the server, a modified central image by using the transmitted modification data and the central image identified by the transmitted unique identifier without requiring transmission of image data from the local terminal to the server.

The present invention yet further provides an image communication method between a local terminal storing local images and a server storing central images, which respectively correspond to the local images, with unique identifiers respectively associated with the central images, comprising steps of:
modifying a local image included in the local images to generate a modified local image;
generating modification data indicating modification made by said modifying means; and
transmitting the modification data from the local terminal to the server together with one of the unique identifiers identifying one of the central images so that the server creates a modified central image by using the transmitted modification data and the central image identified by the transmitted unique identifier without requiring transmission of image data from the device to the server.

The present invention also provides an image communication method between a local terminal storing local images and a server storing central images, which respectively correspond to the local images, with unique identifiers respectively associated with the central images, comprising steps of:
receiving modification data indicating modification carried out in the local terminal together with one of the unique identifiers; and
modifying one of the central images identified by the transmitted unique identifier by using the transmitted modification data without requiring the transmission of image data from the local terminal to the server.

The present invention further provides an image communication method for a system including a local terminal storing local images and a server storing central images, which respectively correspond to the local images, with unique identifiers respectively associated with the central images, comprising steps of:
modifying images included in the system as the local or central images;
exchanging modification data indicating modification made in said modifying step means between the local terminal and the server together with one of the unique identifiers identifying one of the central images; and
synchronising the local images and the central images by modifying images within the system by using the exchanged modification data and the transmitted unique identifier without requiring the exchange of image data between the local terminal and the server.

By way of example only, embodiments of the present invention will now be described with reference to the accompanying drawings, of which:

FIG. 1 is an overview of a network system suitable for use with the present invention;

FIG. 2 is an exemplary gallery of digital images;

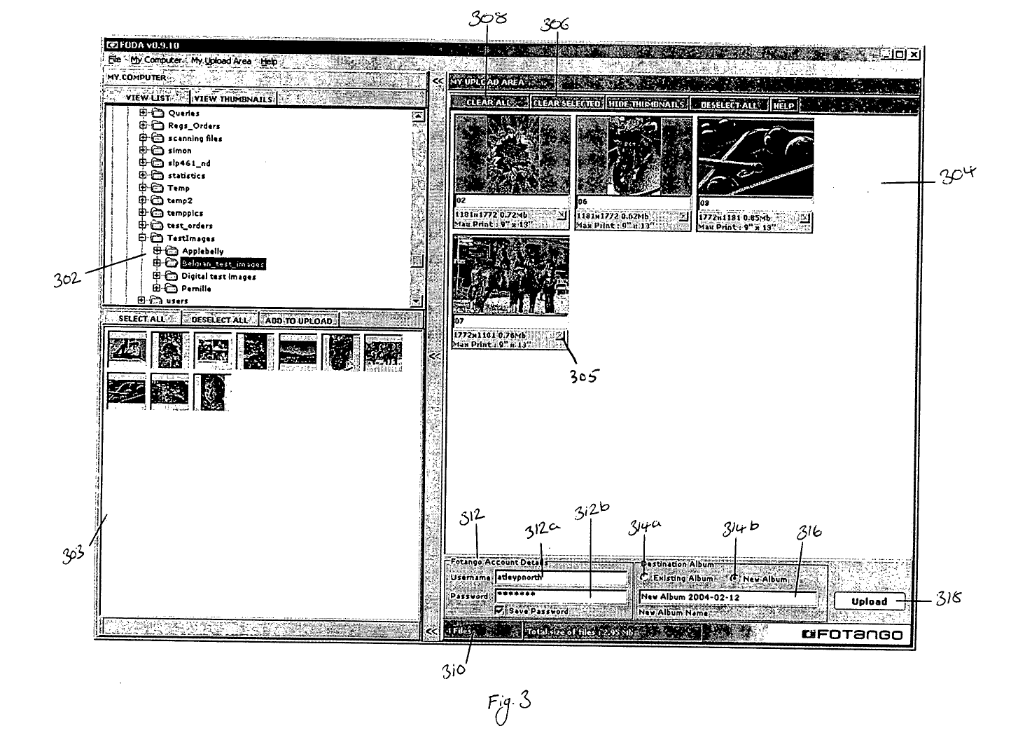

FIG. 3 shows a graphical user interface for a local terminal that can be used to organise the uploading of images to a central server;

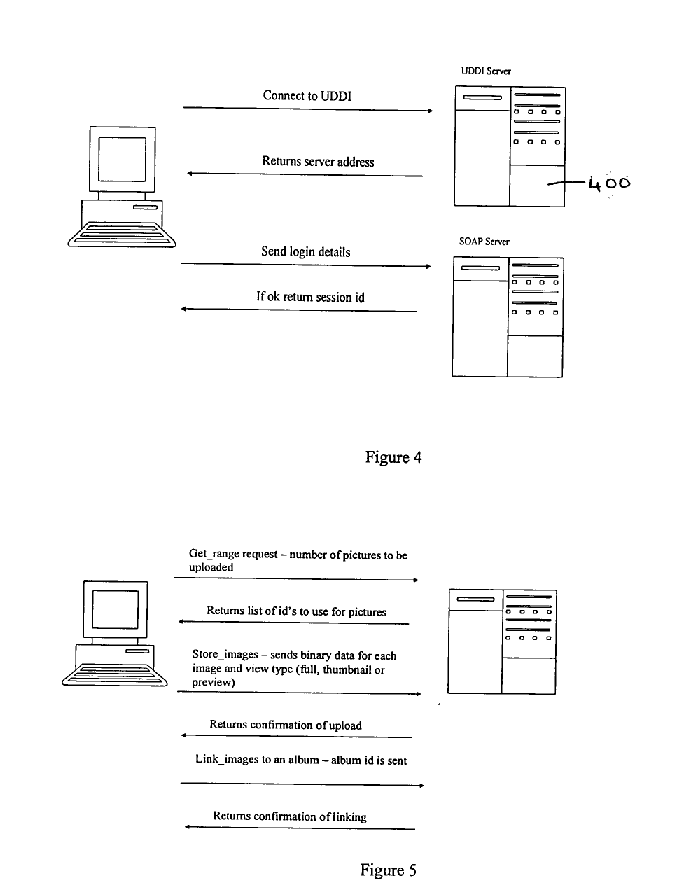

FIG. 4 shows steps performed to setup an initial connection between a local terminal and a server;

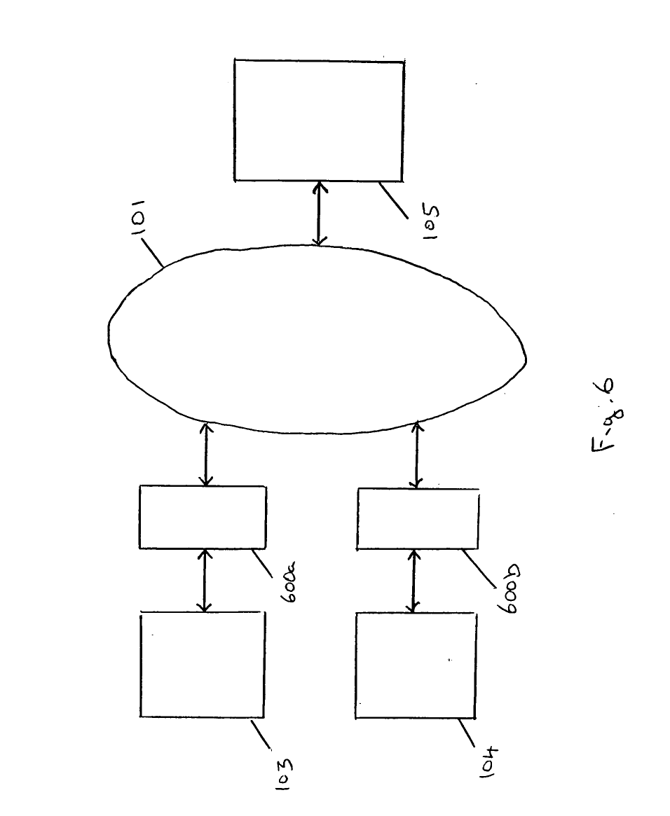

FIG. 5 shows steps performed to upload a number of digital images from a local terminal to a server;

FIG. 6 demonstrates the synchronisation process between two local terminals and a central server in accordance with an aspect of the present invention;

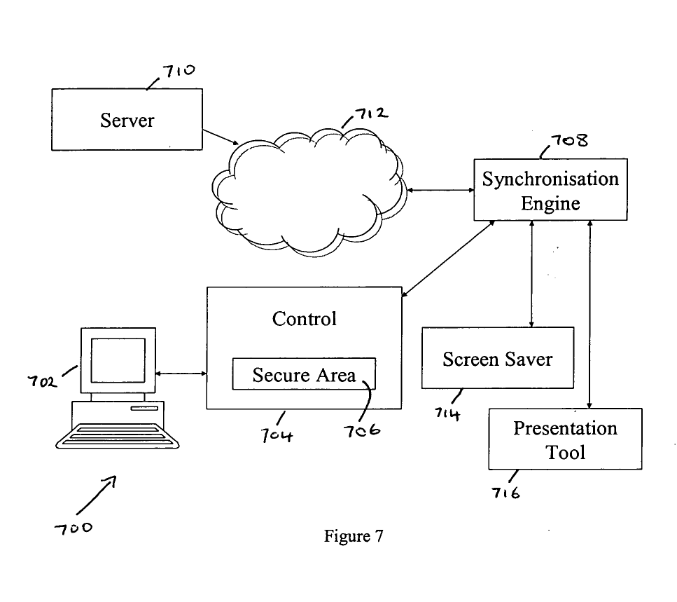

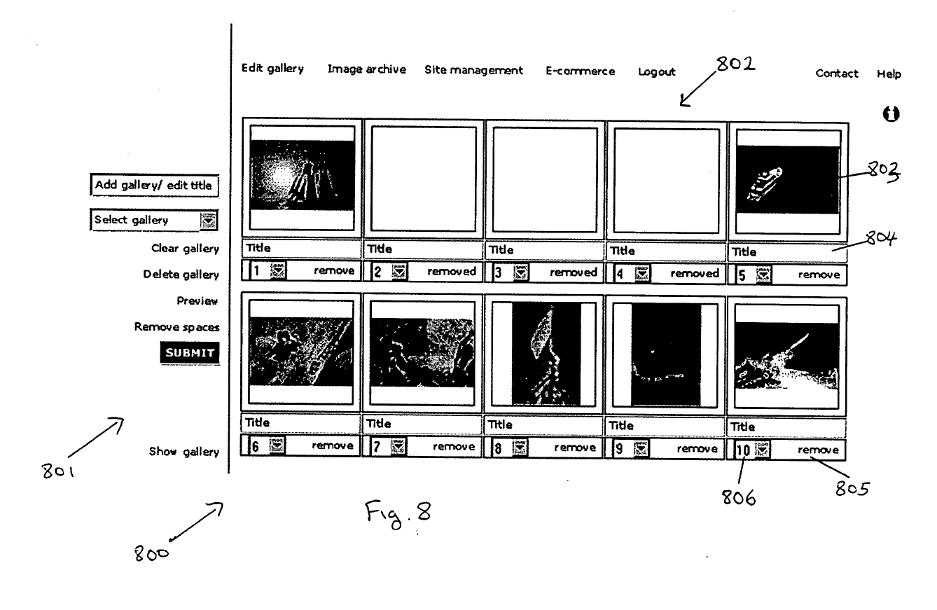

FIG. 7 shows a system in accordance with an aspect of the present invention; and

FIG. 8 shows a digital gallery editor that can be used in an embodiment of the present invention.

User terminals 102, 103 and 104 allow the user to upload digital images and the like to the server computer 105. FIG. 3 shows a graphical user interface (GUI), indicated generally by the reference numeral 300, that can be used to organise the uploading of digital images to the server 105. The GUI 300 is split into three portions: a directory structure 302, a file list 303 and an upload area 304.

The directory structure 302 displays the directory structure of the local user terminal 102, 103 or 104. In the example of FIG. 3, the directory structure 302 is represented using the well-known Windows™ Explorer™ look and feel. Clearly, any other suitable representation of the directory structure could be used.

The file list 303 displays files in a selected directory. In the use of the GUI 300, a directory is selected in the first portion 302 and suitable files in that directory are displayed in the second portion 303.

The upload area 304 shows the images that have been selected for uploading to the server computer 105.

The file list 303 and the upload area 304 only show files having a supported format. For example, if JPEG files are the only files that are supported, only JPEG files will be visible in the file list 303 and upload area 304.

In use, a directory is selected from the directory structure 302 by clicking on the relevant icon, as is conventional. When a directory in the directory structure 302 is selected, all valid files (e.g. all JPEG files) in that directory are shown in the file list 303. The file list may take one of many forms. For example, the file list may show thumbnail images of the images in the selected directory, as shown in FIG. 3. Alternatively, a list view may be selected. If a list view is selected, a list of file names is given in the file list 303. If a thumbnail view has been selected, thumbnails are shown unless the images have dimensions larger than a preset value as this would take up a large amount of system resources. In such circumstances, a standard image is shown in place of the thumbnail image. The size of the image in pixels and megabytes may be listed in the list view and may be made visible in the thumbnail view by hovering a curser over a thumbnail.

Images can be added from the directory structure 302 or the file list 303 to the upload area 304 in a number of ways. If a directory is dragged from either the directory structure 302 or the file list 303 to the upload area 304, then all valid images in that directory are added to the upload area. Files from the file list 303 can be individually dragged to the upload area 304. Similarly, multiple files in the file list 303 can be selected and together dragged to the upload area 304.

The upload area 304 shows images that have been selected for upload to the server 105. The files in the upload area can be shown as thumbnails (as in the example of FIG. 3) or as file lists. If the files are shown as thumbnails, the following information is also displayed: the title of the image, the size of the image in pixels (width×height), the file size in megabytes and the maximum recommended print size in inches (images printed at sizes above this will have a low print quality). If the files are shown as file lists, the above information is displayed and, in addition, the full path to the image file and the compression ratio of the file are also displayed. The compression ratio gives an indication as to whether the image has been compressed enough to significantly affect the image quality.

Images can be removed from the upload area 304 by selecting the image (by clicking on it) and pressing the delete key, or by clicking on a small cross 305 next to the image to be deleted. There are two clear buttons at the top of the upload area 304: a clear selected button 306 and a clear all button 308. Clicking on the clear selected button 306 deletes a selected image. Clicking on the clear all button 308 deletes all images in the upload area 304. It should be noted that deleting images from the upload area 304 does not delete those images from the directory structure of the local terminal.

The order of the images in the upload area 304 can be changed by dragging an image to a new position and then dropping the image. The image is then inserted in the new position and the following images are moved along.

An upload area information bar 310 is located at the bottom of the upload area 304. The information bar 310 indicates the number of files in the upload area 304 (four in the example of FIG. 3) and the total size of the files in megabytes (2.95 Mb in the example of FIG. 3).

When an image is added to the upload area 304 a number of checks are performed on it. The image is checked to determine whether or not it is a valid image file by opening the file and checking that it is valid (rather than simply relying on the file extension). The image is checked to determine whether or not it has already been added to the upload area. Finally, the image is checked to ensure that it is below a preset size (e.g. less than 10,000 pixels). If any of these checks fails, then the file is not added to the upload area 304.

Before images can be uploaded to the server 105, the user must login to an account on that server by entering the relevant details into the login bar 312 positioned in the example of FIG. 3 directly above the information bar 310.

The user enters a username into box 312a and a password into box 312b. The user must also indicate whether the images are to be loaded into an existing file (by selected button 314a) or a new file (by selecting button 314b). If a new file is to be created, the file name must be given in box 316. In the example of FIG. 3, the images are being uploaded to a new album called “New Album 2004-02-12”.

The upload process is started by clicking on the upload button 318 in the bottom right hand corner of the upload area 304.

The first step of the upload process is the initial connection that must be made between the local terminal 104 and the server 105. This connection is demonstrated in FIG. 4.

The local terminal 104 contacts a Universal Description, Discover and Integration (UDDI) server 400 and requests the address of the central server 105. In the example of FIG. 4, the server 105 is implemented as a Simple Object Access Protocol (or SOAP) server. The use of a UDDI server ensures that the SOAP server 105 can be relocated as needed and also allows for a level of flexibility. This can be used for load balancing by having the UDDI server return different server addresses to different users. If the local terminal does not receive a response from the UDDI server, then the upload process terminates at this point with an error.

SOAP is a well-known protocol that provides a simple mechanism for exchanging structured and typed information in a decentralized, distributed environment using XML. Other similar data exchange mechanisms may be used. Many suitable mechanisms are well known to persons skilled in the art and the reference to the SOAP protocol and to the use of a UDDI server herein should be treated as being purely exemplary.

If the local terminal 104 gains access to the SOAP server 105, the login information entered by the user is used to login to the service provided by the server 105. If the username and password are valid, then the server 105 returns a session identification to the local terminal, as shown in FIG. 4. This session identification must be used for all communications between the local terminal and the server 105 for the duration of the upload process. The initial connection from the local terminal 104 to the server 105 is now complete.

If the user has requested to upload the images to an existing album, then the local terminal queries the server 105 for a list of albums that is currently on the user's account. Once the local terminal 104 has that list, a dialogue box with a drop down list box is displayed at the local terminal and the user can select the album into which the images in the upload area should be uploaded. If the user has requested to upload to a new album, then the local terminal sends the details of the new album and the server returns an identification for the new album.

FIG. 5 demonstrates the steps taken to upload images to the SOAP server 105. The first step in the uploaded process is for the local terminal to inform the server 105 of the number of images that are to be uploaded. The server 105 returns a list of unique ids that are to be used for the images. The local terminal then begins to transmit the images to the server 105.

In one embodiment of the invention, images are transmitted in chunks from the local terminal to the server 105. Images are added to the chunk until the chunk exceeds are configurable size. This ensures that extremely large amounts of data are not sent to the server and that the upload times are reasonable. It also allows for some images to be uploaded even if an upload attempt fails. Each image in a chunk is assigned a unique identification provided by the server 105. In an alternative embodiment of the invention, images are sent one by one. In this embodiment, the local terminal waits for confirmation that a particular image has been correctly received at the server before sending a further image. This embodiment has the advantage that if a particular upload attempt fails, only data relating to that particular image need be re-sent.

Data is then encoded into a SOAP packet and sent to the server 105. The progress of the packet is monitored and an estimate of the time required to send the remainder of the packet determined and displayed. Once the data has been sent and the server has confirmed that it has been received, that data is linked to the destination album. Once this step has been successfully completed, the images in the transmitted chunk are removed from the upload area 304 of the local terminal.

Once the first chunk has been successfully transferred to the server 105, the next chunk of images is prepared and sent. The transmission of chunks continues until all of the images in the upload area have been transmitted to the server 105 or an error occurs. Any images not successfully uploaded are left in the upload area 304.

In addition to being able to upload images from the local terminal 104 to the server 105, the user is able to synchronise the local terminal to the server and vice-versa. This means that changes made offline to images on the local server can be uploaded to the server when the local terminal connects to the server 105. Similarly, changes made on the server whilst the local terminal 104 is offline (made by local terminal 103, for example) can be downloaded to the local terminal 104 when the local terminal 104 connects to the server 105.

The synchronisation process is controlled by a synchronisation engine, described below with reference to FIG. 6.

FIG. 6 shows two user terminals 103 and 104. User terminals 103 and 104 are connected to synchronisation engines 600a and 600b respectively. Each synchronisation engine then connects, via Internet network 101, to the server 105.

The purpose of synchronisation engine 600a is to synchronise an object from the server 105 to the user terminal 104 and vice-versa. If the user terminal 104 requests an update of an object, the synchronisation engine 600a sends the object identification for that object to the central server 105. The synchronisation engine 600a may also send a timestamp of the last update of that object. If the full current state of that object is required, then no timestamp is sent.

In response, the server 105 sends all elements of the object that have changed since the last timestamp. The elements are returned in the form of synchronisation data together with a new timestamp representing the time of the synchronisation data.

The timestamp is controlled by the server and is stored by the synchronisation engine 600a. This ensures that no problems are encountered if the time is set differently on the server 105 and the synchronisation engine 600a.

In the case of the object being a collection (such as a collection of images organised into a gallery), the server 105 will check all items that are contained within the collection as well as the properties of the collection itself, returning all information that has changed since the last timestamp recorded by the synchronisation engine 600a or 600b. Care must be taken to ensure that all objects held within the requested object are checked.

Consider the case of a gallery of digital images, such as the gallery 202 shown in FIG. 2, wherein the gallery is stored on the server 105 and the user terminal 104 stores a local copy of that gallery. Consider the situation where the gallery is modified at server 105 in some way whilst the user terminal is offline. When the connection to the server 105 is re-established, the synchronisation engine 600a updates the user terminal 104 with the changes made at the server 105.

The synchronisation engine 600a sends the identification of the gallery 202 to the server 105 together with a timestamp of the last update. The server 105 then checks all elements of the gallery 202 to determine whether they have changed since the last timestamp. For example, the title of the gallery may have changed or images may have been added, moved, renamed or edited since the last timestamp.

In a similar way, any changes that have been at the user terminal 104 since the last timestamp can be uploaded to the server 105. Clearly, it is necessary to consider the case where contradictory modifications are made when the local terminal is offline. For example, an image may be rotated clockwise in the copy of the gallery stored at the local terminal but deleted from the version stored at the server. There are many ways in which this situation could be dealt with. For example, a conflict message may be sent to the user(s) concerned requesting a decision on which modifications should take priority. Alternatively, a particular remote terminal may have priority over any other remote terminal.

Terminal 103 interacts with the central server 105 via synchronisation engine 600b in the same way as terminal 104 interacts with central server 105 via synchronisation engine 600a.

In the example of FIG. 6, the synchronisation engine 600a and 600b and located between the local terminals 103 and 104 and the network 101. This is not essential. The synchronisation engines may be located anywhere in the system and may be divided, with some parts at the local terminal(s) and some parts at the server 105.

FIG. 7 shows a system, indicated generally by the reference numeral 700, in accordance with an embodiment of the present invention. The system 700 includes a user terminal 702. The user terminal is associated with a control program 704 described below. The control program incorporates a secure area of memory 706. The control program 704 is in communication with a synchronisation engine 708. The synchronisation engine 708 can connect to a server 710 via an Internet connection 712. In the example of FIG. 7, the synchronisation engine 708 is also connected to a screen saver program 714 and a presentation tool 716.

The control program 704 controls a graphical user interface that enables an operator to operate the system. The graphical user interface may be similar to the GUI 300 described with reference to FIG. 3. Alternatively, the graphical user interface may be in the form of a digital gallery editor, such as the digital gallery editor 800 shown in FIG. 8.

The digital gallery editor 800 comprises a menu 801 to modify parameters relating to a digital gallery 802. The menu 801 can also be used to create new galleries or to edit or delete existing galleries.

The digital gallery 802 includes a number of thumbnails 803. Each thumbnail has data 804 and 805 and a position indicator 806 associated with it. Data 804 and 805 may include some of owner identification data, the title of the image and the date of shooting of the digital image.

The control program 704 displays a copy of the most recently known version of digital gallery 802 on the digital gallery editor 800. If the user terminal is connected to the server 710, this copy will be kept up-to-date by the synchronisation engine 708. If the user terminal 702 is offline, the local copy may become out-of-date.

In either case, a user at user terminal 702 can add images to the local copy of a digital gallery 802 in a manner similar to the adding of images to the upload area 304 of FIG. 3. When an image is added to the local copy of the digital gallery 802, a copy is taken of that image by the control program 704 and stored in the secure area 706. This copy may be encrypted and/or hidden from the user in some way. Keeping a copy of the image is the secure area 706 ensures that the original image added to the system is retained, even if the image when added to the digital gallery 802 is subsequently altered in some way.

When the synchronisation engine 708 is connected to the server 710, the new image that has been added to the secure area 706 is copied to the server 710. This is done as a background process.

An image can be purged from the secure area to reclaim disk space on the user terminal 702. In such circumstances, the locally stored thumbnail and preview images will be retained. This original image will, however, be maintained at the server.

An image can also be deleted using the user terminal 702. The instruction to delete the image will be sent to the server 710 via the synchronisation engine 708. Once this has been done, the image can be deleted from the secure area 706. Since the control program 704 stores a local copy of the digital gallery 802, images within the digital gallery 802 can be manipulated locally by the user. This does not require a connection to the server 710 and can therefore be done when no connection is available. Also, since the manipulations are being carried out offline, the process is relatively quick.

Manipulations of images remain local until they are committed by the user. Once manipulations are committed, they are synchronised to the server 710 via the synchronisation engine 708.

In one embodiment of the invention, modifications are handled as described below. An image is uploaded from a local terminal to the server and stored at the server as an original image and assigned a unique identifier. A list of modifications associated with a particular image is stored separately. When an image is required (e.g. a request to print the image is received), a new image is created, from the original image, with all the modifications for the modification list being applied to the original image in order to obtain the modified image. The new image may be created in an optimised manner, e.g. by combining two successive rotation instruction into a single rotation instruction. By way of example, modification details may be stored at the server in XML format.

At the local terminal, after the original image is uploaded to the server, the local terminal receives the unique identifier associated with that image from the server. That unique identifier is then used for further communications between the local terminal and the server relating to that image. When modification made at the local terminal are to be synchronised with the server, a list of modifications is sent to the server together with the unique identifier for the image.

Accordingly, images at stored at the server in their original format, thereby avoiding any loss in image quality associated with the traditional method of repeatedly manipulating the image and saving the manipulated image. Further, as noted above, all modification can be combined in an optimal manner before being applied to the original image to reduce unnecessary manipulations which would lead to a degradation of the image.

As discussed above with reference to FIG. 6, the synchronisation process includes updating all aspects of the image that have changed. This requires only sending data relating to the changes. These changes, which might include image rotation, cropping, zooming, re-sizing or red-eye reduction, can then be performed on the copy of the image stored at the server. Thus, only data relating to those changes are required to be transmitted over the internet connection 712. This generally requires substantially less data to be transferred than transferring the manipulated image in full.

Consider the situation where a user uploads a digital image from a digital camera to an account stored at a central server. Later, that user accesses his account from a first local terminal (terminal 1) and crops the image. Later, the user logs on to the account from a different terminal (terminal 2) and rotates the image. Finally, the user logs on to the account from the first local terminal (terminal 1) and adjusts the colour of the image.

According to prior art methods, this process requires the following steps:
Uploading the original image from the digital camera to the central server.
Downloading the original image from the server to the first local terminal and cropping the image using software at the local terminal.
Uploading the cropped image from the first local terminal to the server.
Later, downloading the cropped image from the server to the second local terminal and rotating the image using software at the second local terminal.
Uploading the rotated image from the second local terminal to the server.
Downloading the rotated image from the server to the first local terminal and adjusting the colour of the image using software at the first local terminal.
Uploading the colour-adjusted image to the central server.

If the user were using a system in accordance with the system described above with reference to FIG. 7, the process would require the following steps:
Uploading the original image from the digital camera to the central server.
Downloading the original image from the central server to the first local terminal and cropping the image using software at the first local terminal.
Uploading data relating to the cropping function from the first local terminal to the server.
Downloading the original image and the data relating to the cropping function from the central server to the second local terminal. Performing the cropping function at the second local terminal to recreate the cropped image and rotating the cropped image using software at the second local terminal
Uploading the details of the rotation from the second local terminal to the central server.
Downloading the rotation details from the central server to the first local terminal, performing that rotation at the first local terminal to recreate the rotated image and performing the colour adjustment, as described above.
Uploading the details of the colour adjustment from the first local terminal to the central server.

Thus, according to the prior art method, the image (either the original or one of the modifications of the original) is transmitted to and from the central server a total of seven times. Using the system described above, the original image need only be transmitted once from the digital camera to the server and once from the server to each of the first and second local terminals. In addition, data relating to the modifications are also sent.

Clearly, transferring data relating only to the modifications to the original image can result in a significant reduction in the amount of data transferred. Furthermore, the quality of the final image stored at the server is better if successive manipulations are performed on the original image, rather than sending lots of manipulated images back and forth between the local terminals and the server, since each successive manipulation would further degrade the original image.

The control program 704 is one example of many programs that can be built on top of the synchronisation engine 708. Two other examples: screensaver 714 and presentation tool 716 are shown in FIG. 7.

The screensaver program 714 can be used to generate a screen saver incorporating images from a digital gallery, such as the digital gallery 802. The screensaver can be distributed by sending an email to the desired recipients and allowing those recipients to download the screen saver application.

The screensaver synchronises with the server 710 via the synchronisation engine 708 using login details supplied in the email. Images in a digital gallery can then be displayed as part of the screensaver.

If the digital gallery is amended by the user, then the changes are automatically synchronised to the screensaver program by the synchronisation engine 708.

By way of example, consider a screensaver consisting of a slideshow of digital images of a baby. The grandparents of the baby may wish to have access to the screensaver: this can be achieved as described above by sending an email containing login details to enable the synchronisation engine 708 to obtain the relevant images from the digital gallery stored at the server 710.

Each time the screensaver application is launched, the application checks with the synchronisation engine 708 to see whether any of the images have been changed (by checking the timestamps, as discussed above). Any changes are then transmitted to the local copy of the screensaver application. Accordingly, if the screensaver application is modified by uploading more recent images of the baby to the central server, the synchronisation engine 708 will automatically update the images on the grandparents' screensaver application.

The presentation tool 716 allows digital images, video clips and sounds to be organised into a presentation collection. The user can go to any personal computer connected to the Internet and install the presentation tool 716. The synchronisation engine 708 can then be used to synchronise with the server 710 so that the presentation can be given at any location with Internet access. Further, if the presentation tool is left installed at a location, the tool can be kept updated with any changes to the presentation.

Consider the example of a lecturer who regularly makes a particular presentation that develops over time. Rather than take a laptop computer containing the entire presentation, or a disk containing the latest version of the presentation each time the presentation is given, the presentation tool 716 is installed at the location(s) where the presentation is given. Thus, the presentation can be amended at the server 710 and the synchronisation engine 708 used to update the local copy of the presentation.

The description above has generally been restricted to digital images, especially digital still images. It should be understood, however, that the principles discussed apply equally to the organisation and manipulation of digital video movies as digital moving images.

1. An image communication device connectable to a server storing central images with unique identifiers respectively associated with the central images, the device comprising:
means for storing local images corresponding to the central images;
means for modifying a local image included in the local images to generate a modified local image;
means for generating modification data indicating modification made by said modifying means; and
means for transmitting the modification data to the server together with one of the unique identifiers identifying one of the central images so that the server creates a modified central image by using the transmitted modification data and the central image identified by the transmitted unique identifier without requiring transmission of image data from the device to the server.

2. A device according to claim 1, further comprising storing means for storing the modification data capable of indicating a set of modifications carried out by said modifying means while the device is disconnected from the server.

3. A device according to claim 2, wherein said transmitting means transmits the modification data after the device is subsequently connected to the server.

4. A device according to claim 1, further comprising means for receiving modification data indicating modification carried out in the server together with one of the unique identifiers, and wherein said modifying means is capable of modifying the local image corresponding to the central image identified by the received unique identifier to create a modified local image by using the received modification data without requiring transmission of image data from the server to the device.

5. A device according to claim 4, wherein the received modification data is capable of indicating a set of modifications carried out in the server and said modifying means includes means for generating one or more optimised modifications corresponding to the set of modifications and means for applying the optimised modifications to the local image.

6. A device according to claim 1, wherein the device is connectable to the server via an Internet connection.

7. An image communication device connectable to a local terminal storing local images, the device comprising:
means for storing central images with unique identifiers respectively associated with the central images;
means for receiving modification data indicating modification carried out in the local terminal together with one of the unique identifiers; and
means for modifying a central image, which is stored in said storing means as one of the central images, identified by the transmitted unique identifier by using the transmitted modification data without requiring transmission of image data from the local terminal.

8. A device according to claim 7, wherein the modification data received by said receiving means is capable of indicating a set of modifications carried out in the local terminal and said modifying means includes means for generating one or more optimised modifications corresponding to the set of modifications and means for applying the optimised modifications to the central image.

9. A device according to claim 7, wherein said modifying means is capable of modifying a central image included in the central images irrespective of the modification data transmitted from the local terminal.

10. A device according to claim 9, further comprising:
means for generating modification data indicating modification made by said modifying means; and
means for transmitting the modification data to the local terminal together with one of the unique identifiers identifying one of the central images so that the local terminal creates a modified local image by using the transmitted modification data and the local image identified by the transmitted unique identifier without requiring transmission of image data from the device to the local terminal.

11. An image communication system comprising a server and a local terminal connectable to the server, wherein central images are stored in the server with unique identifiers respectively associated with central images, and wherein local images corresponding to the central images are stored in the local terminal, the system further comprising:
means for modifying, at the local terminal, a local image included in the local images to generate a modified local image;
means for transmitting modification data indicating modification made by said modifying means from the local terminal to the server together with one of the unique identifiers identifying one of the central images; and
means for creating, in the server, a modified central image by using the transmitted modification data and the central image identified by the transmitted unique identifier without requiring transmission of image data from the local terminal to the server.

12. An image communication method between a local terminal storing local images and a server storing central images, which respectively correspond to the local images, with unique identifiers respectively associated with the central images, comprising steps of:
modifying a local image included in the local images to generate a modified local image;
generating modification data indicating modification made by said modifying means; and
transmitting the modification data from the local terminal to the server together with one of the unique identifiers identifying one of the central images so that the server creates a modified central image by using the transmitted modification data and the central image identified by the transmitted unique identifier without requiring transmission of image data from the device to the server.

13. An image communication method between a local terminal storing local images and a server storing central images, which respectively correspond to the local images, with unique identifiers respectively associated with the central images, comprising steps of:
receiving modification data indicating modification carried out in the local terminal together with one of the unique identifiers; and
modifying one of the central images identified by the transmitted unique identifier by using the transmitted modification data without requiring the transmission of image data from the local terminal to the server.

14. An image communication method for a system including a local terminal storing local images and a server storing central images, which respectively correspond to the local images, with unique identifiers respectively associated with the central images, comprising steps of:
modifying images included in the system as the local or central images;
exchanging modification data indicating modification made in said modifying step means between the local terminal and the server together with one of the unique identifiers identifying one of the central images; and
synchronising the local images and the central images by modifying images within the system by using the exchanged modification data and the transmitted unique identifier without requiring the exchange of image data between the local terminal and the server.
